(19) United States
(12) Patent Application Publication
(10) Pub. No.: US 2010/0141868 A1
(43) Pub. Date: Jun. 10, 2010

(54) Replicated bragg selective diffractive element for display illumination

(75) Inventors: Pierre St. Hilaire, Belmont, CA (US); Thomas L. Credelle, Morgan Hill, CA (US)

Correspondence Address: VAN PELT, YI & JAMES LLP, 10050 N. FOOTHILL BLVD #200, CUPERTINO, CA, 95014, US

(73) Assignee: Holox Technologies, Inc.

(21) Appl. No.: 12/589,311

(22) Filed: Oct. 20, 2009

Related U.S. Application Data
(60) Provisional application No. 61/196,975, filed on Oct. 21, 2008.

(51) Int. Cl. G02F 1/13357

(52) U.S. Cl. 349/62

(57) ABSTRACT

A system for a display is disclosed. The system comprises an illumination source, a light guide, and a diffractive element. The illumination source inserts illumination into the light guide. The diffractive element extracts illumination from the light guide. The diffractive element comprises a modulated diffractive structure.

### CROSS REFERENCE TO OTHER APPLICATIONS

This application claims priority to U.S. Provisional Patent Application No. 61/196,975 (Attorney Docket No. ALLVP008+) entitled REPLICATED BRAGG SELECTIVE HOLOGRAPHIC ELEMENT FOR DISPLAY ILLUMINATION filed Oct. 21, 2008, which is incorporated herein by reference for all purposes.

### BACKGROUND OF THE INVENTION

Most liquid crystal displays (LCDs) comprise active element 174 including a liquid crystal material, which acts as a shutter, and a backlight assembly to provide a source of light (FIG. 1A). The backlight assembly typically includes illumination source 160, such as a fluorescent lamp(s) or light emitting diode(s) (LED(s)), light guide 162 to transmit light using total internal reflection, extraction means 164 (e.g., scattering dots on the rear of the light guide), rear reflector 166, diffuser 168, one or more light redirection film(s) 170, and polarization recycling film 172. Each function is therefore separate and controlled by individual plastic sheets or coatings. Multiple sheets lead to loss of light through reflections, to increased thickness, and to additional cost. These sheets can also cause Moire effects or rainbow effects, which degrade image quality. In addition, the function of each film may not be well matched to the desired optical output, leading to lost light throughput efficiency.

### BRIEF DESCRIPTION OF THE DRAWINGS

Various embodiments of the invention are disclosed in the following detailed description and the accompanying drawings.

FIG. 1A is a block diagram showing prior art for a backlight structure for display illumination.

FIG. 1B is a block diagram illustrating an embodiment of a perspective view of a diffractive structure for display illumination.

FIG. 1C is a block diagram illustrating an embodiment of a diffractive structure for display illumination.

FIG. 1D is a block diagram illustrating an embodiment of a diffractive element.

FIG. 2 is a block diagram illustrating an embodiment of a diffractive structure for display illumination from the viewer side.

FIG. 3 is a graph illustrating an embodiment of a efficiency versus wavelength.

FIGS. 4A and 4B are block diagrams illustrating embodiments of a lower spatial density and a higher spatial density of diffractive structure.

FIG. 4C is a block diagram illustrating an embodiment of a continuously varying diffractive structure.

FIG. 5 is a diagram illustrating an embodiment of a system for illumination using a diffractive element.

FIGS. 6A and 6B are diagrams illustrating embodiments of a diffractive structure for a display illumination.

FIGS. 7A and 7B are diagrams illustrating embodiments of a diffractive structure for a display illumination.

FIG. 8 is a block diagram illustrating an embodiment of a system for illuminating a display.

FIG. 9 is a block diagram illustrating an embodiment of a system for illuminating a display.

FIG. 10A is a block diagram illustrating a section of a diffractive structure for display, illumination.

FIG. 10B is a block diagram illustrating a section of a diffractive structure for display illumination incorporating height modulation.

FIG. 10C is a block diagram illustrating a section of a diffractive structure for display illumination incorporating wall thickness modulation.

FIG. 10D is a block diagram illustrating a section of a diffractive structure for display illumination incorporating transverse height modulation.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A modulated Bragg-selective diffractive element for display illumination is disclosed. High aspect ratio, slanted diffractive structures use Bragg selectivity to efficiently extract light toward the viewer from a substantially planar light guide. These elements exhibit the useful properties of volume holograms such as
a. high efficiency: diffractive elements exhibiting the Bragg effect can reach an efficiency higher than 99%;
b. high angular selectivity: a diffractive element can be engineered to efficiently redirect light via diffraction coming from a narrow range of angles while leaving the rest unscattered;
c. specular selectivity: a diffractive element can be engineered to efficiently diffract light coming from a narrow range of wavelengths while having no effect on wavelengths outside the prescribed wavelengths;
d. high polarization selectivity: a diffractive element can be engineered to efficiently redirect light via diffraction of one polarization state while having no effect on light of the other polarization state; and
e. Low scatter: a diffractive element can be used in a manner such that very little light is lost outside of the prescribed field.

Volume holograms that are interferometrically written offer considerable performance advantages for applications that require high efficiency, low noise, and Bragg selectivity. However, these structures require the use of expensive materials such silver halide, dichromated gelatin, or photopolymers. Moreover, they cannot be replicated by embossing, imprinting, or injection molding. Each element has to be individually manufactured by interferometric techniques, which can be difficult and expensive. The added cost of volume holograms precludes their use in automotive, solar concentrating, or consumer applications (such as display screens or LCD backlights) despite their performance advantages.

The disclosed structures exhibit the features of volume holograms while maintaining the low cost replication of planar structures. This is achieved by first writing high aspect ratio, vertical or slanted structures within a photosensitive material. These structures can then be economically mass replicated by injection molding or nano-imprinting onto a light guide. Injection molding is a well-established technique in which a plastic is injected into a mold as a liquid, and then solidifies. The surface pattern of the mold is left imprinted onto the part after the mold is removed. Most plastic parts are manufactured by a variant of the technique. Nano-imprinting refers to a class of technologies in which the desired pattern is stamped or imprinted continuously or non-continuously onto a surface coated with a photopolymer, in a manner akin to traditional rubber stamping. After stamping or imprinting the photopolymer is UV cured and the part is unmolded. Both techniques can resolve surface features down to tens of nanometers if used properly. However, nano-imprinting generally allows the creation of thicker structures, or structures having a higher aspect ratio, than does embossing.

Light propagating through the light guide is efficiently diffracted into a prescribed range of angles by a diffractive element (e.g., a periodic, slanted grating) due to Bragg selectivity and the properties of extraction from the light guide using the diffractive element can be modulated across the surface of the light guide element. These diffractive elements can be used for both back and front illumination in a display. Front illumination mode is possible because the Bragg selective property of the structures minimizes light scattered from the environment or from diffuse sources. In addition, the diffractive element is transparent. These structures are of possible use as LCD back or front illuminators, or with any display technology that is either reflective or transmissive.

In order to achieve desired properties for the illumination extracted from a light guide (e.g., view angle, cone of light propagating out, polarization characteristics, wavelength characteristics, broadband wavelength characteristics, narrowband wavelength characteristics, brightness, efficiency, spatial distribution, etc.), different diffractive structures are placed on the surface or the surface is modulated. In some embodiments, a calculation is made for structures that achieve an individual characteristic and these calculated structures are convolved with structures calculated for a different individual characteristic. In various embodiments, diffractive structure characteristics are different in different locations to achieve the desired properties, where the characteristics comprise one or more of the following: diffractive structure depth, pitch, height, orientation, slant, 3-dimensional geometry, extent, or any other appropriate characteristic.

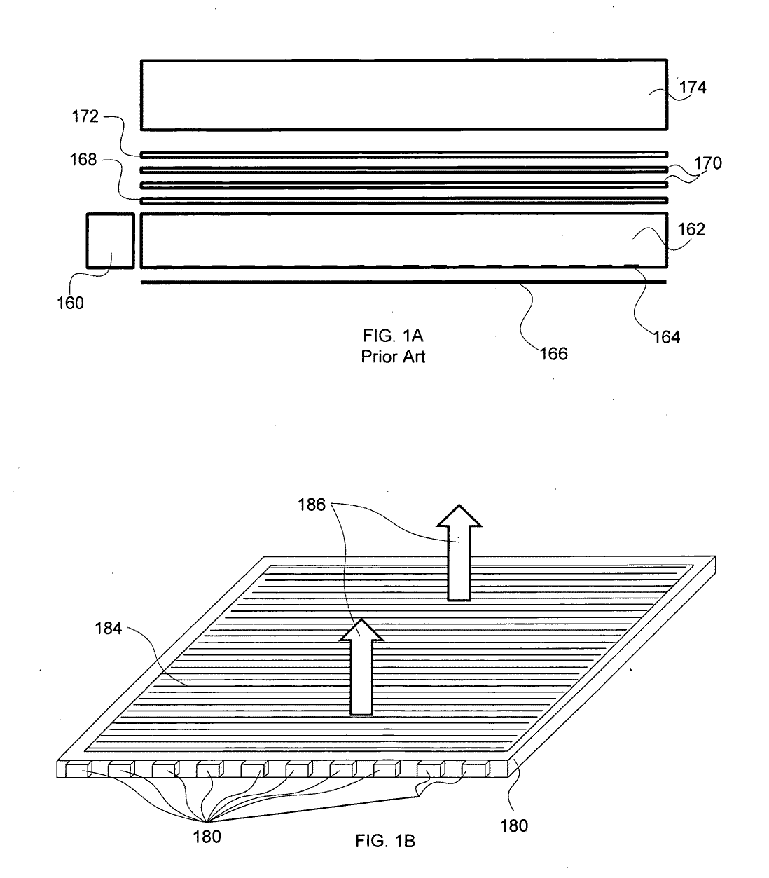

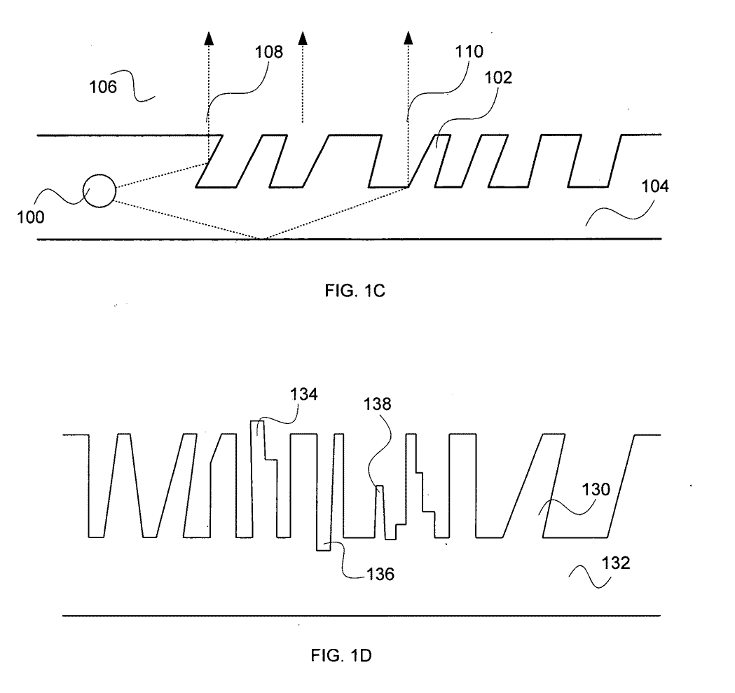

FIG. 1B is a block diagram illustrating an embodiment of a perspective view of a diffractive structure for display illumination. In the example shown, a plurality of sources 180 inject light into light guide 182. The injected light is diffracted using modulated diffracted structure 184 to a display (not shown in FIG. 1B, but generally in the direction indicated by arrows 186).

FIG. 1C is a block diagram illustrating an embodiment of a diffractive structure for display illumination. In the example shown, illumination source 100 injects light into light guide 104, which is then diffracted (e.g., light path 108 and light path 110 from light guide 104 to air 106) using modulated diffractive structure 102 (e.g., a Bragg selective diffractive element or a slanted grating). The diffracted light from the diffractive structure can be viewed by an observer that is viewing the structure at the top of FIG. 1C (viewer is not shown). In some embodiments, the slanted grating is laminated onto a separate substrate, with the grating-substrate combination acting as the light guide allowing the light to be transmitted through the diffractive structure. In various embodiments, source 100 comprises a coherent source, an incoherent source, a light emitting diode, a laser, a diode laser, a cold cathode florescent lamp (CCFL), or any other appropriate source. In various embodiments, light guide 104 is comprised of a photopolymer, a plastic, a glass, or any other appropriate material for a light guide. In some embodiments, source 100 comprises multiple LED sources on one edge of a thin light guide. The light guide comprises either a flat or tapered plastic or glass element whose purpose is to conduct light from the LEDs over the area of the light guide by total internal reflection. In various embodiments, a typical light guide has a range of thickness from 0.3 mm to 1 mm for a cell phone or is as thick as 5-10 mm for larger LCDs such as LCD TV, or any other appropriate thickness for any appropriate application. In various embodiments, the edge of the light guide nearest the LED sources includes either refractive or diffractive optics to direct the light into the light guide. In various embodiments, other light sources are incorporated—for example, one or more CCFLs or one or more other illumination sources. In various embodiments, light sources are incorporated along one or more edges depending on the amount of light required.

It should be noted that unlike traditional light guides, there are no scattering elements or refractive elements along the light guide; all the light extraction is accomplished by the diffractive elements.

FIG. 1D is a block diagram illustrating an embodiment of a diffractive element. In the example shown, the aspect ratio depicted in FIG. 1D is not to scale. The actual aspect ratio is higher than illustrated. In some embodiments, the horizontal extent of a structure is around 100 nm, and the vertical dimension exceeds 1 micron. Structure 130 comprises a high aspect ratio structure etched into substrate 132. In various embodiments, structure 130 comprises a structure that has a significant extent (e.g., tens of microns, hundreds of microns, millimeters, etc.), has a narrow extent (e.g., tens of nanometers, hundreds of nanometers, a few microns, etc.), or any other appropriate extent. Structure 130 depicts a slanted structure.

Structure 130 has straight side walls with a slanted profile. Structure 138 depicts a straight structure with straight side walls also etched into substrate 132. Structure 138 is shorter than structure 130. Structure 134 depicts a straight structure with a side wall having a complex structure. Structure 134 is taller than structure 130. Space 136 is farther into substrate 132.

In some embodiments, substrate 132 and the one or more diffractive structures comprise the same material(s) and/or are manufactured at the same time as a continuous piece.

In various embodiments, structures are straight, are slanted, are a mixture of straight and slanted, are the same heights, are a mixture of heights, have similar side walls, have a mixture of different side walls, sit on a similar substrate level, sit on a mixture of different substrate levels, or any other appropriate structure configuration.

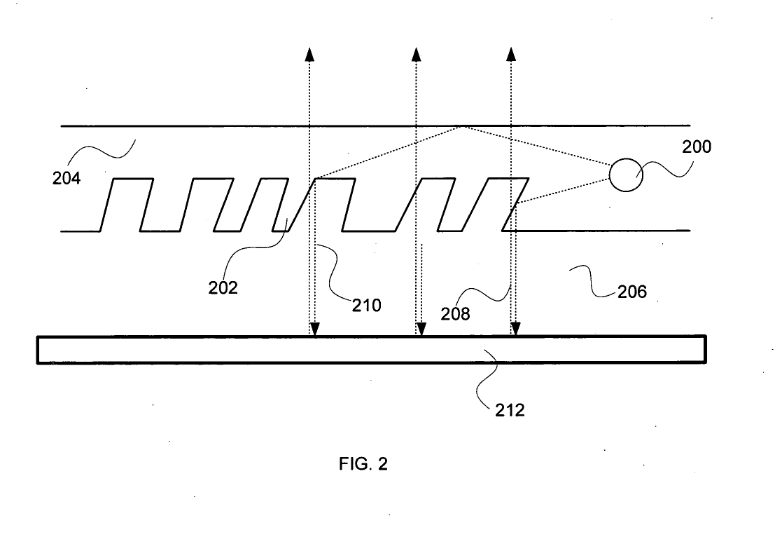

FIG. 2 is a block diagram illustrating an embodiment of a diffractive structure for display illumination from the viewer side. In the example shown, illumination source 200 whose light is traveling within light guide 204 is diffracted (e.g., light path 208 and light path 210 from light guide 204 to air 206) using slanted diffractive structure 202 (e.g., a Bragg selective diffractive element). The diffracted light from the slanted diffractive structure (e.g., a high aspect ratio grating) can be viewed by an observer that is viewing the structure at the top of FIG. 2 (viewer is not shown). The diffracted light is viewed after being reflected off of reflective surface 212 at the bottom of FIG. 2.

To adjust the amount of light extracted from the modulated diffractive structure, two approaches can be used. The first approach is to adjust the amount of light extracted by modulating the diffractive structure parameters. For example, if the diffractive structure height, width, or wall thickness is changed, the extraction efficiency can be changed. Thus over the surface of the light guide, the diffractive structure parameters are slowly changed to create a uniform illumination of the display.

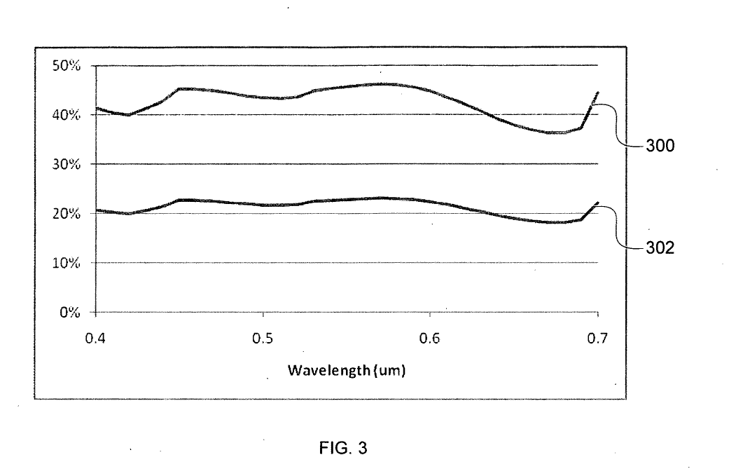

FIG. 3 is a graph illustrating an embodiment of a efficiency versus wavelength. In the example shown, two different sets of diffractive structure were modeled and the efficiency versus wavelength over the visible spectrum was calculated. The results for the first diffractive structure are shown in upper curve 300. Upper curve 300 indicates that the efficiency of diffraction out of a light guide is approximately 40% for visible wavelengths of light from 0.4 μm to 0.7 μm. The results for the second diffractive structure are shown in lower curve 303. Lower curve 302 indicates that the efficiency of diffraction out of a light guide is approximately 20% for visible wavelengths of light from 0.4 μm to 0.7 μm. In a display backlight, the second diffractive structure or lower efficiency diffractive structure is used closest to the light source (e.g. a light emitting diode (LED)) and the first diffractive structure or higher efficiency is used farther away from the light source. The diffractive structure parameters such as pitch, height, slant, wall thickness, shape are adjusted to achieve the desired uniform light output over the specified viewing angle and color and polarization.

A second approach to adjusting the efficiency of the system is to create different spatial density regions of diffractive structures that have the same efficiency. For example, to extract less light, a lower density of diffractive structure is used (e.g., less area of diffractive structure per unit area); to extract more light, a higher density is used (e.g., more area of diffractive structure per unit area).

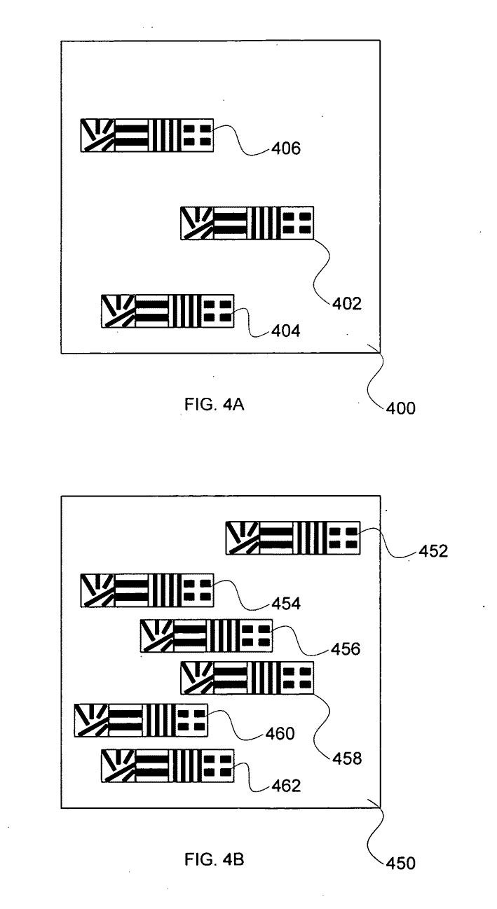

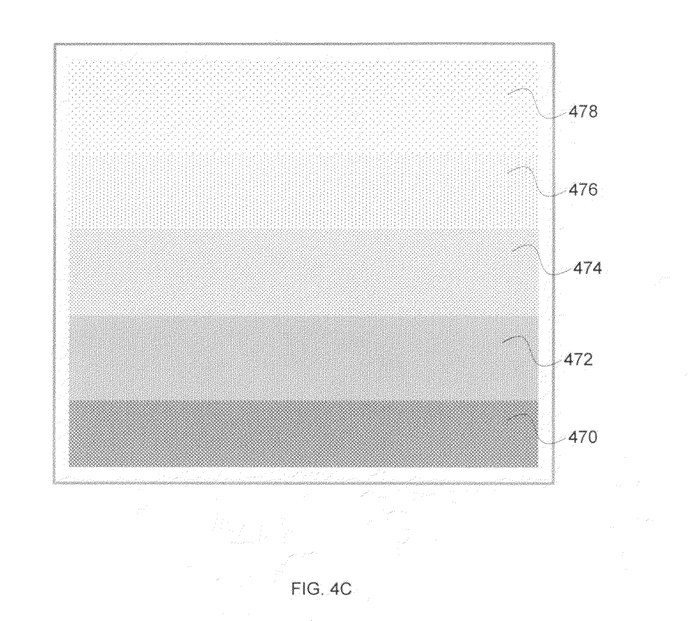

FIGS. 4A and 4B are block diagrams illustrating embodiments of a lower spatial density and a higher spatial density of diffractive structure. In the example shown in FIG. 4A, area 400 has diffractive structure set 402, diffractive structure set 404, and diffractive structure set 406. A diffractive structure set comprises one or more diffractive structures that are determined based on a desired illumination profile of the light that is diffracted from a light guide—for example, a desired view angle, a desired color, a desired brightness, a desired polarization, etc. In the example shown in FIG. 4B, area 450 has diffractive structure set 452, diffractive structure set 454, diffractive structure set 456, diffractive structure set 458, diffractive structure set 460, and diffractive structure set 462. The density of the diffractive sets and the elements that make up the diffractive sets are chosen to achieve a desired illumination profile. In various embodiments, the density of diffractive sets varies over an area (e.g., area 400 or area 450), the elements making up the diffractive sets vary over an area, or any other appropriate variation of diffraction structures over the area to achieve a desired illumination profile.

FIG. 4C is a block diagram illustrating an embodiment of a continuously varying diffractive structure. In the example shown, instead of small regions of different diffractive structures as in FIGS. 4A and 4B, the diffractive structure is designed to have continuously varying properties across the light guide surface to achieve the desired illumination. Regions 470, 472, 474, 476, and 478 have different properties that affect uniform light extraction, polarization control, angle control or another optical property. In various embodiments, the boundaries between regions or within the regions have smoothly varying structures (e.g., no discontinuities in the desired diffractive structures between regions), have stepwise varying structures (e.g., discontinuity in the diffractive structures between regions), have a combination of discontinuous and continuous structures within or between regions, or any other appropriate diffractive structures to achieve the desired optical properties (e.g., throughput, polarization, angle deflection, spectral selectivity, etc.).

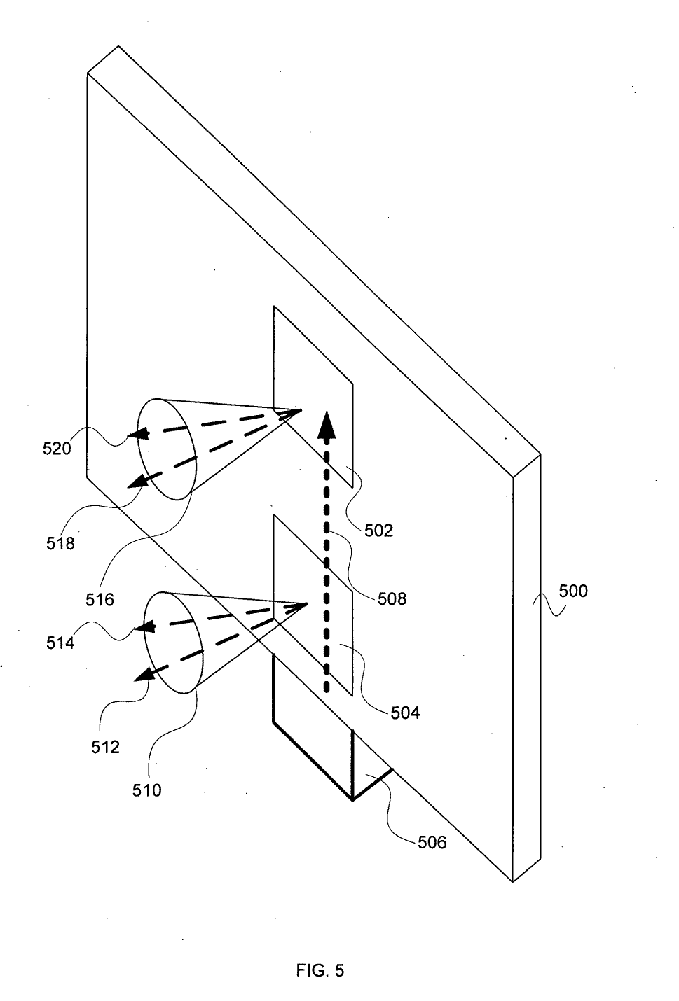

FIG. 5 is a diagram illustrating an embodiment of a system for illumination using a diffractive element. In the example shown, light guide 500 receives illumination from light source 506. Light source 506 inserts illumination (e.g., narrow band or broadband illumination; coherent or incoherent illumination; collimated or diverging; specular or diffuse.) into light guide 500 from one edge of light guide 500. Light propagates through light guide 500 (e.g., along path indicated by 508). Area 502 and Area 504 include diffractive structure sets of different spatial densities and/or different structural set make ups. Area 502 and area 504 extract light from light guide 500 as appropriate to achieve a desired illumination distribution (e.g., light having cone distribution 510 or cone distribution 516 with rays 512, 514, 518, and 520 of appropriately selected intensity, polarization, and color). Extraction of the illumination takes place along a face of light guide 500 that is perpendicular to the edge through which the illumination is inserted into light guide 500.

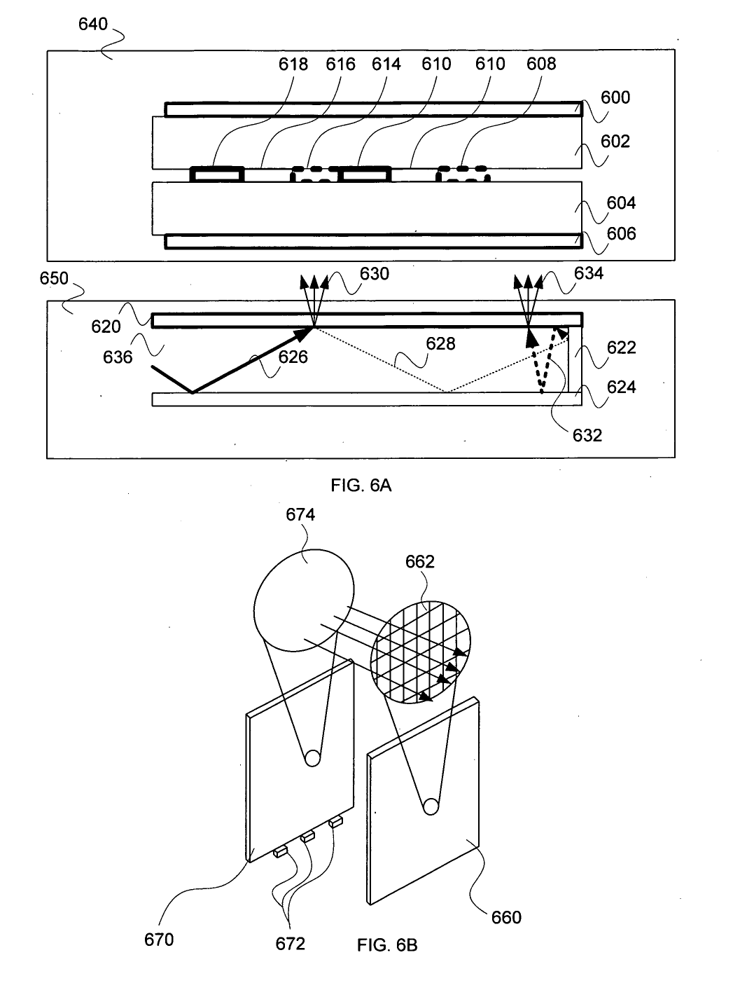

FIGS. 6A and 6B are diagrams illustrating embodiments of a diffractive structure for a display illumination. In the example shown in FIG. 6A, backlight system 650 (in cross section view) illuminates Liquid Crystal Display (LCD) system 640. LCD system 640 includes S-polarizer 606, substrate 604, pixilated layer where a given pixel corresponds to a color (e.g., pixels 608, 610, 612, 614, 616, and 618 where pixel 608 and pixel 614 represent a first color pixel, pixel 610 and pixel 616 represent a second color pixel, and pixel 612 and pixel 618 represent a third color pixel), substrate 602, and P-polarizer 600. Backlight system 650 comprises diffractive element 620, reflector 622, reflector 624, and light guide 636. Backlight system 650 is aligned with LCD system 640 such that the diffractive structure (e.g., a Bragg selective diffractive element or a slanted grating) on the surface of backlight system 650 propagates light toward an appropriate pixel in LCD system 650 pixel layer. In various embodiments, the light propagated toward the pixel is unpolarized (e.g., light on light path 630 or light path 634), is partially polarized, is completely polarized as appropriate for the LCD system (e.g., S-polarized), or is any other appropriate polarization.

In some embodiments, the diffractive structures are designed to exhibit strong structural birefringence, resulting in one polarization component being coupled out more efficiently by the diffractive structure. In this configuration, the backlight can be used as a pre-polarizer for the illumination of either reflective or transmissive LCD displays. Moreover, the light corresponding to the unscattered polarization direction remains bound within the light guide rather than absorbed. It can then be converted to the correct polarization direction—for example, by placing a ¼-wavelength retardation plate at the end of the light guide (not shown in FIG. 6A or FIG. 6B) and then rediffracted further along the light guide. Using this so-called polarization recycling scheme can result in a potentially twofold increase in backlight efficiency when used in LCD displays. For example, unpolarized light on light path 626 has light extracted (e.g., light along cone 630) for addressing a pixel in LCD system 640 (e.g., with desired brightness, color, polarization—like S-polarization, etc.), which propagates further through the light guide along light path 628 and changes polarization (e.g., from P-polarization to S-polarization either through a birefringence in the light guide material or a ¼-wave plate reflector) so that it can be extracted after propagating along 632 to being extracted (e.g., cone 634) to address another pixel in LCD system 640. In some embodiments, backlight system 650 is approximately 1 mm thick.

In the example shown in FIG. 6B, a perspective view of the embodiment of FIG. 6A is shown; light extracted from backlight system 670 by a diffractive structure illuminates LCD system 660 to create a color image. For example, light sources 672 (e.g., red, green, blue, white, etc.) source light into backlight system 670 which includes different diffractive elements. The diffractive elements extract multiband light from backlight system 670. The light illuminates colored LCD pixels of LCD system 660 (e.g., pixel 662) which control the light that propagates out to a user that enables the user to see a color image.

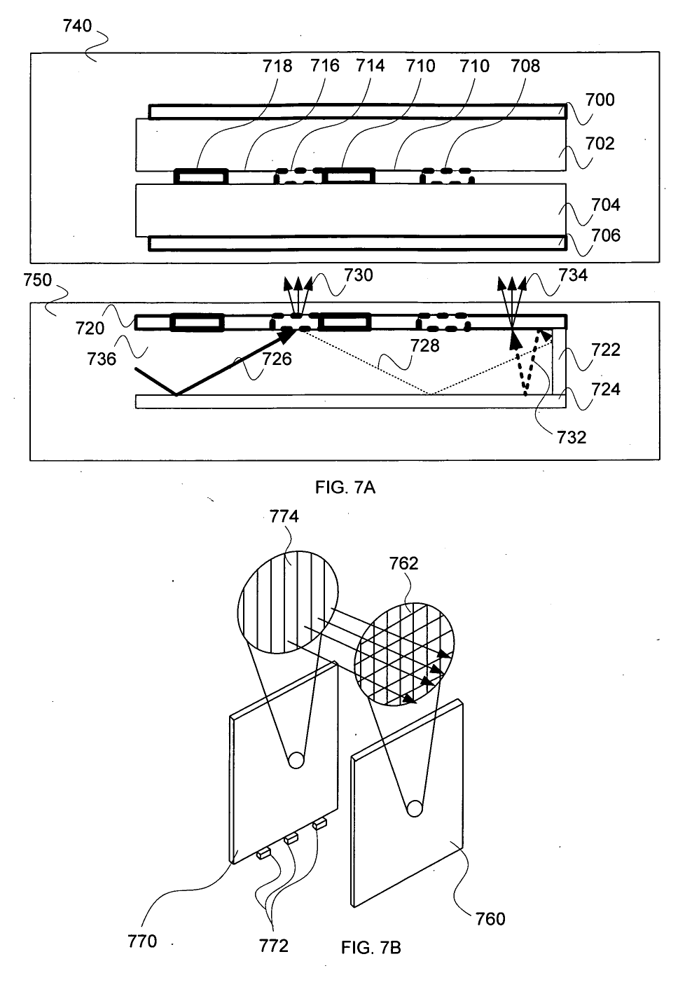

FIGS. 7A and 7B are diagrams illustrating embodiments of a diffractive structure for a display illumination. In the example shown in FIG. 7A, backlight system 750 (in cross section view) illuminates Liquid Crystal Display (LCD) system 740. LCD system 740 includes S-polarizer 706, substrate 704, a pixilated layer where a given pixel corresponds to a color (e.g., pixels 708, 710, 712, 714, 716, and 718 where pixel 708 and pixel 714 represent a first color pixel, pixel 710 and pixel 716 represent a second color pixel, and pixel 712 and pixel 718 represent a third color pixel), substrate 702, and P-polarizer 700. Backlight system 750 comprises diffractive element 720 with different appropriate diffractive elements aligned with pixels (e.g., stripes of pixels with different colors, individual pixels which will get a color), reflector 722, reflector 724, and light guide 736. Backlight system 750 is aligned with LCD system 740 such that the diffractive structure (e.g., a Bragg selective diffractive element or a slanted grating) on the surface of backlight system 750 propagates light toward an appropriate pixel in LCD system 750 pixel layer. In various embodiments, the light propagated toward the pixel is unpolarized (e.g., light on light path 730 or light path 734), is partially polarized, is completely polarized as appropriate for the LCD system (e.g., S-polarized), or is any other appropriate polarization.

In some embodiments, the diffractive structures are designed to exhibit strong structural birefringence, resulting in one polarization component being coupled out more efficiently by the diffractive structure. In this configuration, the backlight can be used as a pre-polarizer for the illumination of either reflective or transmissive LCD displays. Moreover, the light corresponding to the unscattered polarization direction remains bound within the light guide rather than absorbed. It can then be converted to the correct polarization direction—for example, by placing a ¼-wavelength retardation plate at the end of the light guide (not shown in FIG. 7A or FIG. 7B) and then rediffracted further along the light guide. Using this so-called polarization recycling scheme can result in a potentially twofold increase in backlight efficiency when used in LCD displays. For example, unpolarized light on light path 726 has light extracted (e.g., light along cone 730) for addressing a pixel in LCD system 740 (e.g., with desired brightness, color, polarization—like S-polarization, etc.), which propagates further through the light guide along light path 728 and changes polarization (e.g., from P-polarization to S-polarization either through a birefringence in the light guide material or a ¼-wave plate reflector) so that it can be extracted after propagating along 732 to being extracted (e.g., cone 734) to address another pixel in LCD system 740. In some embodiments, backlight system 750 is approximately 1 mm thick.

In the example shown in FIG. 7B, a perspective view of the embodiment of FIG. 7A is shown; light extracted from backlight system 770 by a diffractive structure illuminates LCD system 760 to create a more efficient color image. For example, light sources 772 (e.g., red, green, blue, white, etc.) source light into backlight system 770 which includes different diffractive elements. The diffractive elements extract different color light from backlight system 770 in different spatial areas (e.g., stripe 774). The light illuminates colored LCD pixels of LCD system 760 (e.g., pixel 762) which control the light that propagates out to a user that enables the user to see a color image. For example, stripe 774 produces red (or any other color), and then propagates the color to the corresponding pixels on LCD system 760 (e.g., a red desiring stripe). The color-selective diffractive elements can be used to either replace the color filters of an LCD or can be used to enhance the efficiency of an LCD incorporating color filters; in the latter case, the efficiency is improved because pre-colored light will be more efficiently transmitted by the color filter. Up to a twofold or threefold improvement is possible with this system.

In some embodiments, an LCD system is illuminated by a backlight system. The backlight system is lit using red, green and blue light emitting diodes (LEDs) at the bottom of a lightpipe structure; white LEDs can also be used. A close up of the diffractive structure (e.g., a Bragg selective diffractive element, a grating structure, etc.) is displayed with a corresponding close up of the pixilated layer of the LCD system. In this embodiment, because the slanted structures is patterned and modulated across the backlight surface, it is possible to define regions on the surface of the backlight that only extract a narrow band of wavelengths e.g. red, green or blue. If these regions are aligned with the color filter of a color LCD, then the light transmission through the color filter will be increased by two or three fold. In some embodiments, the spectral selectivity of the hologram is used to improve the color gamut of the LCD by not transmitting wavelengths that normally would cause a reduction in color gamut; for example, the light from a white LED that is between red and green causes a reduction in color gamut with a typical LCD. If this light is not transmitted, then the color gamut will improve. In the example shown in FIG. 7B, a perspective view of the embodiment of FIG. 7A is shown; three separate strips of diffractive structures are shown which extract red, green or blue light in alignment with the color filter structure of the LCD.

In some embodiments, the modulated diffraction structure is designed to direct light from an area larger than a corresponding structure of the pixilated LCD layer (e.g., green light from the areas of a green pixel, a red pixel, and a blue pixel are propagated toward a green pixel on the LCD). In various embodiments, colors associated with the pixilated LCD layer comprise red, green, and blue; or magenta, cyan, yellow, and black; or any other appropriate colors.

In some embodiments, if the diffractive structures (e.g., slanted Bragg gratings) are aligned with the color filters to achieve higher transmission through the LCD, it may be necessary to focus the light in one dimension so that the extracted color only falls on the corresponding color filter i.e. red light only falls on the red color filter. The amount of focusing required is a function of the color filter spacing and the distance between the diffractive structure (e.g., slanted Bragg structure) and the color filter. After the light passes through the LCD, a second diffractive structure is applied which diffuses the light to the desired viewing angles. Since the diffractive structure (e.g., a Bragg grating) does not scatter the light, there will only minor reduction in contrast ratio from ambient light sources falling on the front surface.

In some embodiments, the diffraction structure is designed to narrow or widen the angular distribution of light towards the display.

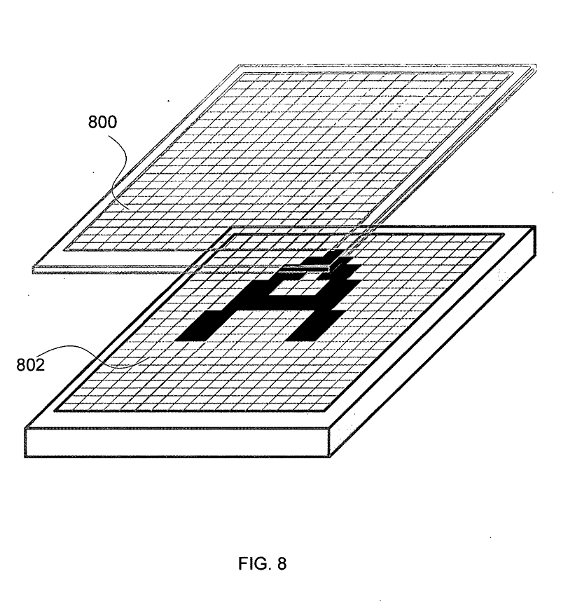

FIG. 8 is a block diagram illustrating an embodiment of a system for illuminating a display. In the example shown, illuminator 800 is positioned above display 802. In this case illuminator 800 is off and display 802 is displaying a monochrome output (e.g., a capital letter A). In various embodiments, display 802 comprises a monochrome electrophoretic, cholesteric display, or any other appropriate monochromatic display, where the media can appear black or appear white.

In some embodiments, an application of the spectral selection property of slanted Bragg diffractive elements (e.g., gratings) previously described is in front-lighting a diffusive monochrome display such as electrophoretic display. In this type of display, there is no backlight and images are created by switching the electrophoretic media from a black state to a white scattering state.

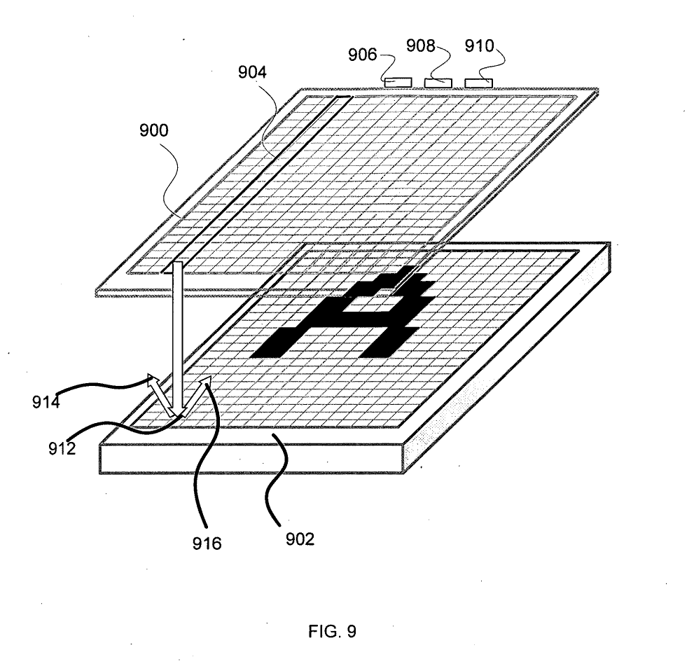

FIG. 9 is a block diagram illustrating an embodiment of a system for illuminating a display. In the example shown, a modulated slanted Bragg diffractive element is patterned so that the color selective areas are in alignment with the pixels of monochrome display 902 and placed as front illuminator 900. This system is capable of showing a color image. Color sources 906, 908, and 910 provide illumination for front illuminator 900. To make a color image, a colored light (e.g., red, green, blue, yellow, magenta, etc.) is extracted (e.g., along stripe 904) and directed towards a black and white pixel 912; if the pixel is desired to the color, then the pixel is set to a white state and the white particles scatter the incident colored light from the front illumination system back to the viewer (e.g., light 916 and 914). Likewise for other colors that are supported with other stripes. The system is able to produce a color image at a lower resolution than a black and white image because each pixel is associated with a color so that the black and white image will have a higher resolution compared to a colors system.

In some embodiments, a diffractive structure is patterned so that the color selective and/or white areas are in alignment with the pixels of the display. This allows a monochromatic display to convert to color and also to increase the apparent brightness because of the addition of a white pixel. In various embodiments, a white pixel is added for brightness, and the orientation of red, green, blue, and white pixels may be in alternate patterns. For the white pixel, white light is extracted from the light guide and directed towards the display and white light is scattered back to the user.

In some embodiments, to achieve intermediate shades of color, the electrophoretic media is adjusted electronically to an intermediate gray level: Thus a monochrome electrophoretic display, such as an electronic book or shelf label can be converted to color when the front illumination system is turned on. When the front illumination system is turned off, the electronic book reverts to a monochrome display.

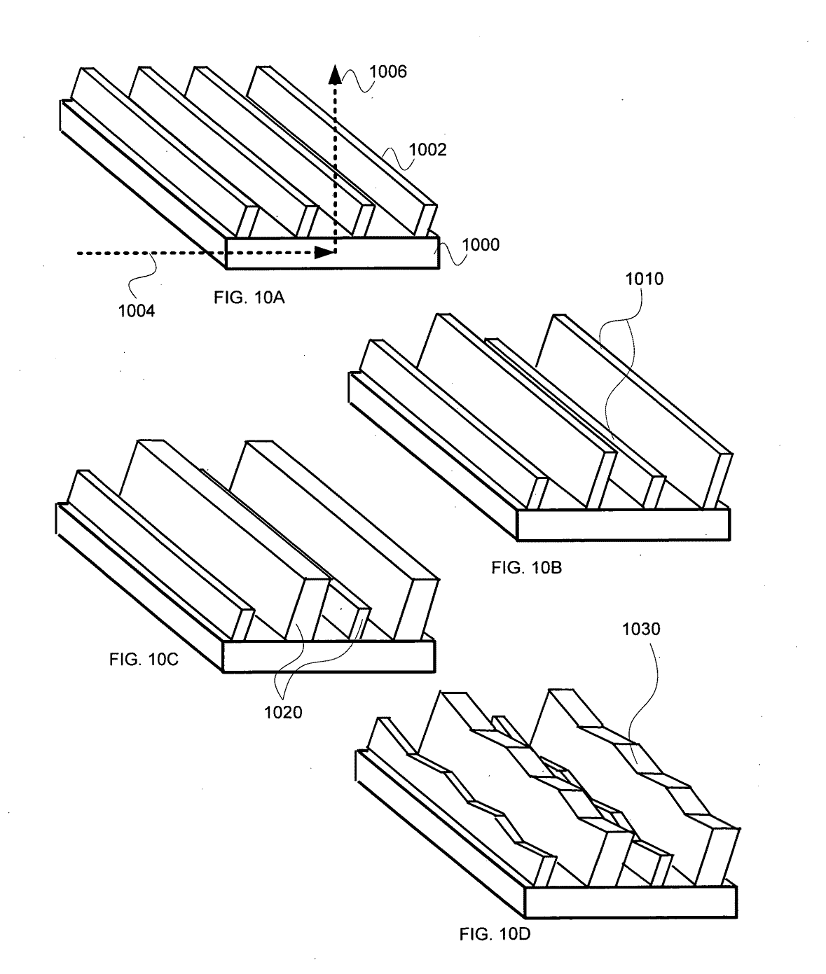

FIGS. 10A, 10B, 10C, and 10D are block diagrams illustrating embodiments of diffractive elements. In the examples shown, the diffractive elements have the properties including the ability to perform one or more of the following: light extraction, spectral selectivity, angle selectivity, efficiency adjustment, or polarization selectivity by the appropriate design of the slant, height, width, pitch, modulation of the height and/or width of one or more diffractive components of the diffractive element or any other appropriate structure. Combining multiple functions in one modulated diffractive element provides a simple low cost solution for a back light system and, in combination with a display element, for a display system. In the example shown in FIG. 10A, slanted grating 1002 extracts light propagating along arrow 1004 from light guide 1000 at a substantially normal angle (e.g., along arrow 1006) to the light flow in light guide 1000. In the example shown in FIG. 10B, a diffraction element wall height is modulated (e.g., as shown by modulated wall heights 1010) to add an additional function to the light path (e.g., adjusting view angle or angle, setting output polarization, adjusting extraction efficiency, color adjustment, etc.). In the example shown in FIG. 10C, the diffraction element wall thickness is modulated (e.g., as shown indicate by 1020) to add another function to the light path. In the example shown in FIG. 10D, the diffraction element feature height is modulated in the transverse direction (e.g., as shown indicated by 1030) in order to add one more additional function to the diffraction element. Many functions desired for light management by the diffraction element are combined in one film that includes the diffraction element through the principles of optical superposition.

In various embodiments of modulated diffractive elements, the variation in feature properties such as height, wall thickness, shape, pitch, or angle varies by other means than shown in FIG. 10A-D—for example, the height variations varies from a minimum to maximum value over several structural elements instead of varying every other one as shown in FIG. 10B, 10C, or 10D; or the variation follows a functional relationship (e.g. sine wave variation) or is randomized to achieve the desired optical function, or has any other appropriate variation. In some embodiments, the orientation of the diffractive structures varies in angle relative to the light path to achieve desired optical function(s).

In some embodiments, a first structure for the diffractive element is calculated given a first desired property of the extracted light; a second structure for the diffractive element is calculated given a second desired property of the extracted light; Repeat for as many desired properties of the extracted light as are desired; Combine all calculated structures for a combined diffractive element structure; Fabricate diffractive element structure; Incorporate diffractive element structure with a light guide (e.g., by positioning or adhering the diffractive structure along a surface of the light guide) to generate a backlight system; and combine the backlight system with a regular display system. In various embodiments, one or more properties (e.g., height, width, slant angle, pitch, shape, wall thickness, orientation, spatial extent of a pattern region, etc.) of the diffractive structure varies across a surface of the light guide, varies in a continuous manner across the surface of the wave guide, varies in a discontinuous manner across the surface of the wave guide, or any other appropriate manner of variation or combination of variation for diffractive structures.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for a display, comprising:
an illumination source;
a light guide, wherein the illumination source inserts illumination into the light guide; and
a diffractive element, wherein the diffractive element extracts illumination from the light guide, and wherein the diffractive element comprises a slanted diffractive structure, wherein one or more properties of the slanted diffractive structure vary across a surface of the light guide.

2. A system as in claim 1, wherein one or more properties of the slanted diffracted structure comprise one or more of the following: a height, a width, a shape, a pitch, an angle, an orientation, a spatial extent, and a wall thickness.

3. A system as in claim 1, wherein the modulated diffractive element comprises one or more slanted diffractive structures that were made using replication.

4. A system as in claim 1, wherein the diffractive element extracts light from a face of the light guide that is substantially perpendicular to an edge through which the illumination source inserts illumination into the light guide.

5. A system as in claim 1, further comprising a display, wherein the extracted illumination illuminates the display.

6. A system as in claim 5, wherein the extraction achieves a viewing angle for the illuminated display.

7. A system as in claim 5, wherein the extraction achieves a uniform light input for the illuminated display.

8. A system as in claim 5, wherein the extraction is based at least in part on a color of light being extracted.

9. A system as in claim 5, wherein the extraction comprises extraction of a broad set of colors.

10. A system as in claim 5, wherein the extraction is based at least in part on a striping of the display.

11. A system as in claim 5, wherein the extraction is aligned with a LCD color filter.

12. A system as in claim 5, wherein the extraction is based at least in part on a polarization of light being extracted.

13. A system as in claim 5, wherein the extraction is based at least in part on a position within the display.

14. A system as in claim 5, wherein two or more functions such as extraction efficiency, angle adjustment, color adjustment, polarization adjustment are combined in one diffractive element.

15. A system as in claim 5, wherein the slanted diffractive structures vary smoothly across the light guide surface.

16. A system as in claim 1, further comprising a monochrome display.

17. A system as in claim 16, wherein the monochrome display is enabled to have a color display.

18. A system as in claim 17, wherein the color display is at a lower resolution than the monochrome display.

19. A system as in claim 1, wherein the light guide for the illumination source recycles polarized light.

20. A system as in claim 1, wherein the extracted illumination provides a front light to the display.

21. A system as in claim 1, wherein the extracted illumination provides a back light for the display.

22. A system as in claim 1, wherein the diffractive element is positioned on a side of the light guide that is closest to a display.

23. A system as in claim 1, wherein the diffractive element is positioned on a side of the light guide that is farthest from a display.

24. A method for a display, comprising:
providing an illumination source;
providing a light guide, wherein the illumination source inserts illumination into the light guide; and
providing a diffractive element, wherein the diffractive element extracts illumination from the light guide, and wherein the diffractive element comprises a modulated diffractive structure.
